(19) United States
(12) Patent Application Publication
(10) Pub. No.: US 2007/0089683 A1
(43) Pub. Date: Apr. 26, 2007

(54) Furniture containing a cage for a pet animal

(76) Inventors: Jimmy R. Roberts, Haskell, TX (US); Jonell Roberts, Haskell, TX (US)

Correspondence Address: JEFFREY F. BIRKEL, 2717 BLACK OAK DRIVE, PEKIN, IL, 61554, US

(21) Appl. No.: 11/254,753

(22) Filed: Oct. 21, 2005

(51) Int. Cl. A01K 1/03

(52) U.S. Cl. 119/477

(57) ABSTRACT

The furniture containing a cage for a pet animal provides an article of decorative furniture having a chamber for holding a pet animal, which may be covered by decorative furniture doors when not in use. A grated cage door is mounted to the furniture housing for selectively covering and sealing the front opening leading into the chamber. An opening is formed through a rear wall of the furniture housing, which is covered by a grated vent, providing airflow through the chamber for the pet animal. A removable tray, a water bottle or interior protective paneling may be optionally added to the chamber for the convenience and care of the pet animal.

### BACKGROUND OF THE INVENTION

1. Field of the Invention

The present invention relates to decorative furniture and to houses or cages for pets, and particularly to furniture containing a cage for a pet animal, the furniture matching the home's interior decor, but having a cage built into the furniture for temporarily housing a dog, cat, or other pet animal.

2. Description of the Related Art

Many different types of pet cages have been utilized to house pet animals, from portable pet carriers to wire metal cages. Such cages generally include a housing large enough to contain the animal and a lockable or latched cage door to prevent the animal from entering and leaving the cage at will. While such pets as dogs and cats are often given free run of the house, it may be desirable to temporarily house the family pet in a cage, e.g., when guests are invited over, or when the owner will be absent from home. Cages and other pet enclosures, however, are typically utilitarian in design and are immediately identifiable as cages and pet housings. Such obtrusive and obvious animal enclosures often clash with the furniture and décor found in the pet owners' homes.

Although pet enclosures having the external appearance of ordinary household furniture have been proposed before, such pet enclosures typically include some sort of cabinet having conventional cabinet doors and construction. In order to confine the pet within the cabinet, the cabinet doors are closed, thus locking the pet inside a dark chamber with little airflow. While such enclosures are effective in confining the animal, the enclosures often deprive the pet of light, or deprive the pet of adequate ventilation, even when a fan is provided.

For these and other reasons, no enclosure for pets that blends in with the furniture and decor of the home has proven entirely satisfactory. Thus, furniture containing a cage for a pet animal solving the aforementioned problems is desired.

### SUMMARY OF THE INVENTION

The furniture containing a cage for a pet animal provides an article of decorative furniture having a chamber for holding a pet animal, which may be covered by decorative furniture doors when not in use. A grated cage door is mounted at the front of the chamber defined by the furniture article for selectively confining the pet to the furniture cage. The article of furniture may be free standing, or may be designed for placement adjacent a wall.

An opening is formed through a rear wall of the furniture housing, which is covered by a grated vent, providing airflow through the interior space for the pet animal. Optionally, louvered shutters may be mounted on the rear wall of the furniture housing, providing a decorative and more conventional appearance to the rear of the furniture, while still providing for air flow for the pet animal contained inside. Further, a removable tray, a water bottle, a food dish, or interior protective paneling may be optionally added to the interior open space for the convenience and care of the pet animal, and to prevent damage to the interior of the furniture.

These and other features of the present invention will become readily apparent upon further review of the following specification and drawings.

### BRIEF DESCRIPTION OF THE DRAWINGS

FIG. 1 is an environmental, perspective view of an article of furniture containing a cage for a pet animal according to the present invention.

FIG. 2 is a-front view of the furniture article of FIG. 1.

FIG. 3 is a side view of the furniture article of FIG. 1.

FIG. 4 is a side view of an alternative embodiment of an article of furniture containing a cage for a pet animal according to the present invention.

FIG. 5 is a rear view of the furniture article of FIGS. 1 and 4.

FIG. 6 is a rear view of another alternative embodiment of furniture containing a cage for a pet animal according to the present invention.

FIG. 7 is a perspective view of a fourth embodiment of the subject furniture containing a cage for a pet animal with an additional tray.

FIG. 8 is a partially exploded side view of a fifth embodiment of an article of furniture containing a cage for a pet animal with additional protective panels.

FIG. 9 is a perspective view of a fourth embodiment of an article of furniture containing a cage for a pet animal with an additional water bottle and food dish.

Similar reference characters denote corresponding features consistently throughout the attached drawings.

### DETAILED DESCRIPTION OF THE PREFERRED EMBODIMENTS

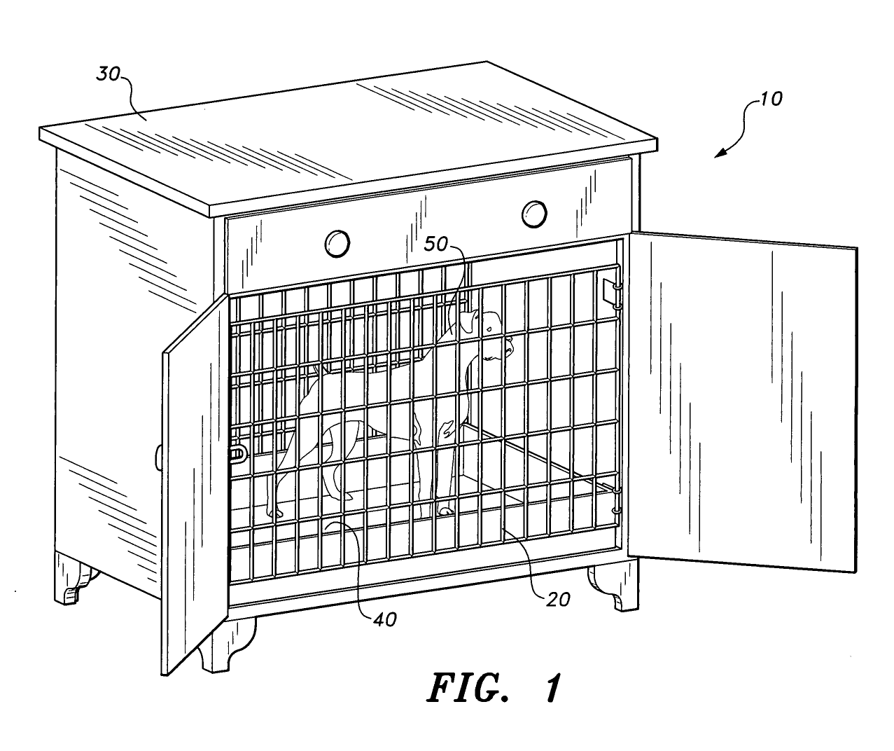

FIG. 1 illustrates a decorative article of furniture 10 having a chamber 40 formed therein for housing a pet animal 50, which may be a dog (as illustrated), a cat or any other conventional house pet. Furniture 10 may be an end table, a nightstand, an entertainment center, a coffee table, a chest, a dresser, or any other suitable article of furniture, which is properly dimensioned and configured to receive an animal.

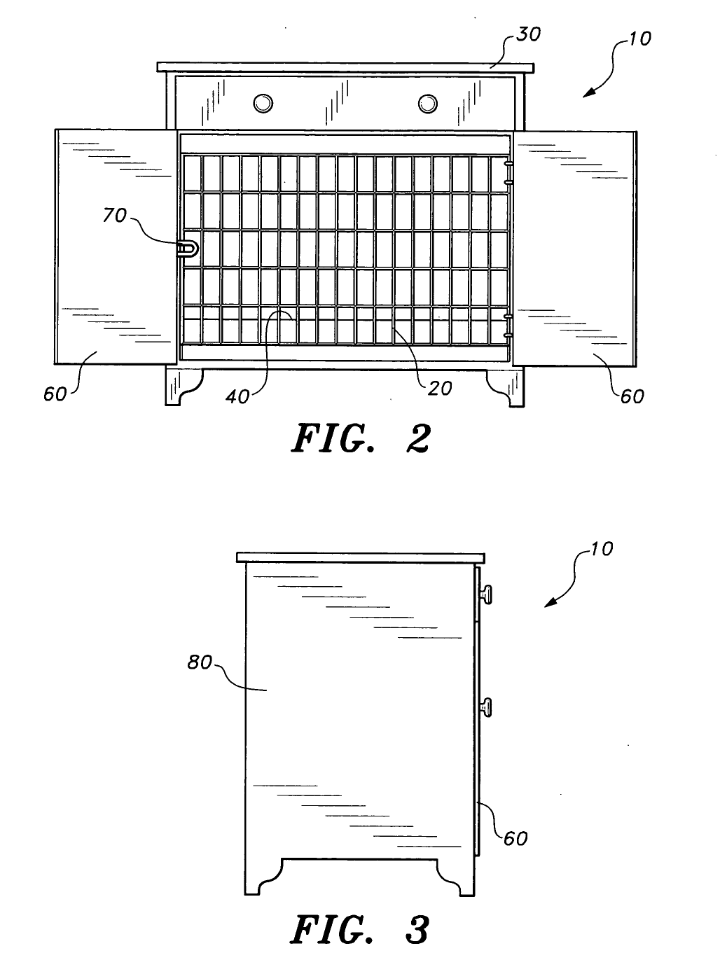

As best shown in FIG. 2 of the drawings, the article of furniture 10 is formed from a furniture housing 30 that is shaped like a conventional article of decorative or ornamental furniture. A chamber 40 is formed within housing 30, and front access to the interior 40 is provided by doors 60. Doors 60 are shown as being a pair of conventional hinged cabinet-type doors. However, it should be understood that the configuration, contouring, number and size of doors 60 are not critical, and will vary with the type of furniture selected. If furniture 10 is a rounded accent chest, for example, doors 60 would be rounded to fit within housing 30. Similarly, doors 60 could be pocket doors, wrap-around doors or any other suitable doors, dependent upon the choice of furniture.

Depending on the configuration of the furniture 10, the interior of housing 30 may be provided with an interior cover or partition, as would be necessary with the use of sliding or rolling doors received within chamber 40 in order to prevent damage to the doors 60 caused by animal 50. The configuration and mounting of doors 60 are dependent upon the desired type of furniture selected by the user.

A grated cage door 20 is pivotally mounted at the front entrance to chamber 40. Grated cage door 20 covers the front opening formed in housing 30, and is positioned behind doors 60. Grated cage door 20 may be selectively locked or latched through actuation and engagement of a latching device 70 for selectively confining animal 50 within housing 30. When not in use, grated cage door 20 may be hidden from view by closing doors 60, thus presenting a conventional furniture facade.

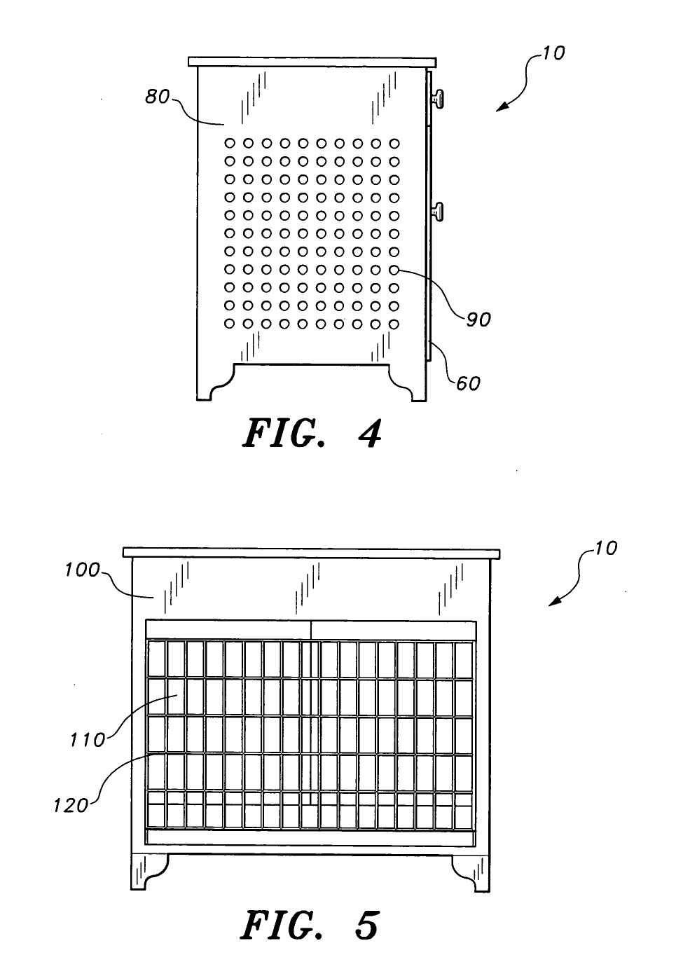

Furniture housing 30 further includes a pair of sidewalls 80, as shown in FIG. 3, which may be standard paneling used in the construction of furniture, such as decorative or ornamental wood. As shown in FIG. 4, a plurality of air vents 90 may optionally be formed through sidewalls 80, providing additional air to an animal 50 housed within furniture housing 30.

FIG. 5 illustrates the rear wall 100 of furniture housing 30, which has an opening 110 formed therethrough. Opening 110 is similar in size and contour to the front opening of housing 30, and a grated vent 120 is mounted to the rear wall 100 over opening 110. Grated vent 120 is similar in configuration to the grated cage door 20. However, the grated vent, 120 is secured on all sides to the rear wall 100, rather than being pivotally attached like cage door 20. Thus, in use, animal 50 is caged between the closed and latched grated cage door 20, the rear grated vent 120 and the sidewalls 80.

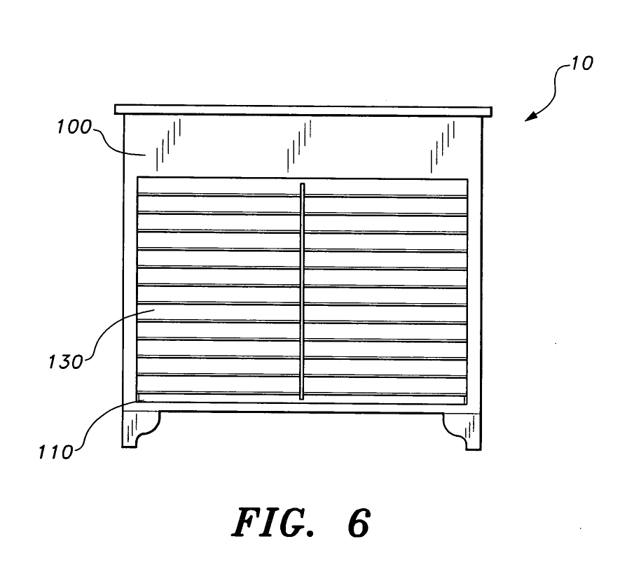

In use, doors 60 may remain open, thus providing airflow for the animal 50 through the cage door 20 and the grated vent 120. Further, airflow may be provided through the addition of the optional air holes 90, shown in FIG. 4. It should be noted that, in the preferred embodiment, cage door 20 and grated vent 120, although mounted to housing 30, are positioned within chamber 40 so that decorative doors 60 and shutters 130 (shown in FIG. 6 and described in detail below) are positioned flush against the exterior of housing 30.

In order to maintain the appearance of conventional furniture, the article of furniture 10 may be positioned so that the rear wall 100 faces the wall of a room, and is adjacent thereto, so that grated vent 120 is not visible. Alternatively, the rear opening 110 may be covered by adjustable shutters, such as louvered shutters 130, illustrated in FIG. 6. In use, shutters 130 are opened, allowing air to flow through the open interior 40 for the animal 50. When not in use, shutters 130 may be closed, thus covering grated vent 120, and presenting the appearance of conventional furniture. Shutters 130 may be painted, stained or otherwise decorated, dependent upon the needs and desires of the user. The use of shutters 130 provides a decorative appearance to the rear wall, so that the article of furniture may be freestanding, such as a coffee table. Alternatively, a set of blinds, or any other suitable adjustable cover, allowing for free flow of air within interior 40, may be utilized.

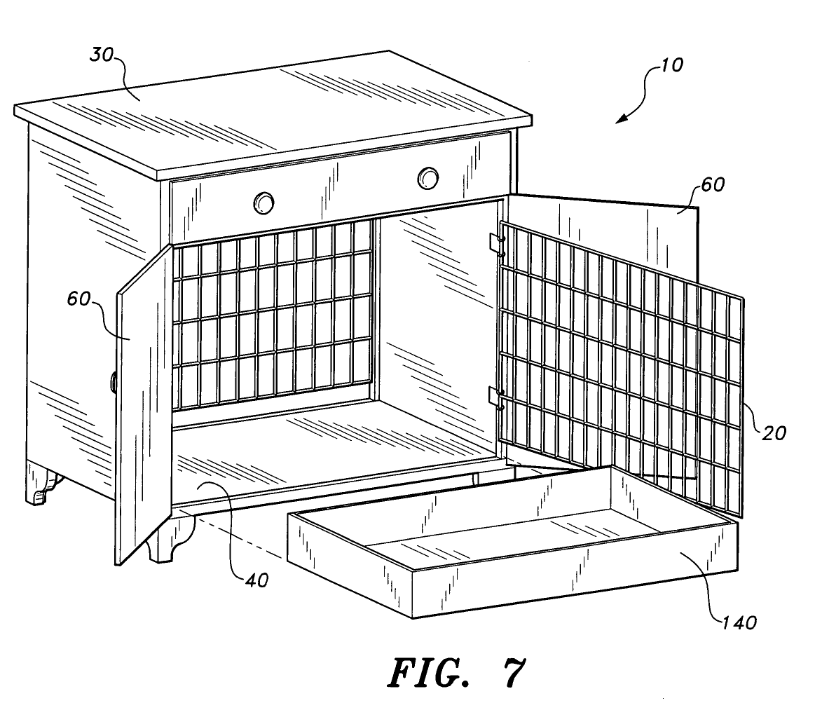

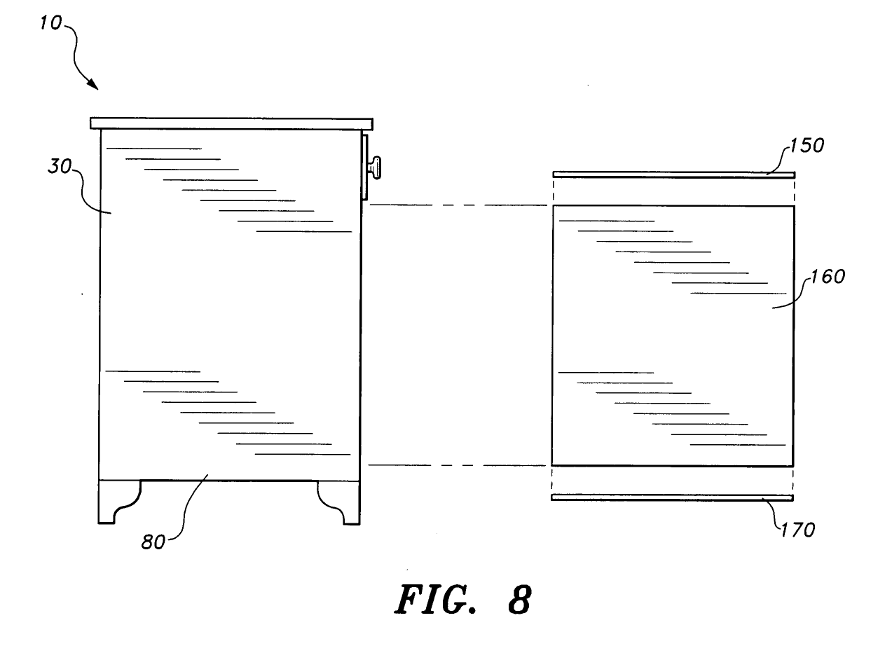

As shown in FIG. 7, an additional tray 140 may be provided for removable reception within chamber 40. Tray 140 is dimensioned and configured to cover the floor of the chamber 40 and is provided to protect the floor of chamber 40 and to collect bodily waste produced by the animal 50. The tray 140 may be removed for cleaning and replacement.

Alternatively, a set of protective panels may be provided for protecting chamber 40, as illustrated in FIG. 8. Lower panel 170 is mounted on the floor of chamber 40, upper panel 150 is mounted on the ceiling of chamber 40, and a pair of side panels 160 are provided for mounting on the sidewalls of the chamber 40. Panels 150, 160 and 170 may be formed of Formica, vinyl, plastic, Plexiglas, or any other suitable materials that provide protection for the interior surfaces of furniture housing 30, are easily cleanable and are nontoxic for the animal 50. Panels 150, 160 and 170 may be removable, or may be permanently fixed to the interior surfaces of housing 30. Panels 150, 160 and 170 protect the interior surfaces of housing 30 from scratching or biting by the animal 50, and from the animal's waste.

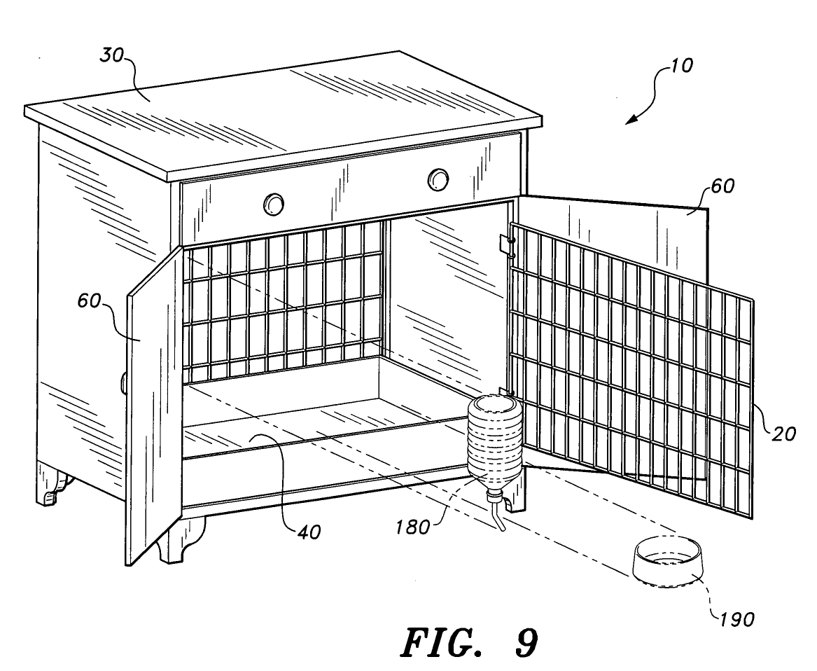

Further, as shown in FIG. 9, a food or water dish 190 and a water bottle 180 may be received within chamber 40. The water bottle 180 may be permanently mounted to an interior sidewall of housing 30, or may be releasably mounted thereon, for replacement and cleaning. Water bottle 180 and dish 190, used in combination with a waste collection apparatus, such as tray 140, allow an animal 50 to be comfortably housed within housing 30 for extended periods of time.

It is to be understood that the present invention is not limited to the embodiments described above, but encompasses any and all embodiments within the scope of the following claims.

We claim:

1. An article of furniture containing a cage for a pet animal, comprising:
a furniture housing having opposed top and bottom walls, a pair of opposed sidewalls joining the top and bottom walls, and a rear wall extending between the sidewalls, the walls being formed from solid panels, the housing defining a chamber dimensioned and configured for housing the pet animal and a front opening leading into the chamber;
a grated door pivotally mounted to the housing, the grated door extending across the front opening when closed;
a releasable latch attached to the housing for releasably latching the door closed in order to confine the pet animal in the chamber; and
a grated vent mounted in the rear wall for providing ventilation.

2. The furniture as recited in claim 1, further comprising at least one furniture door pivotally mounted to said housing, the at least one door selectively covering the front opening and said grated door.

3. The furniture as recited in claim 1, wherein at least one of said sidewalls has a plurality of air vents formed therethrough for providing additional airflow through said chamber.

4. The furniture as recited in claim 1, further comprising a plurality of shutters mounted to said rear wall, said set of shutters covering said grated vent.

5. The furniture as recited in claim 4, wherein said shutters comprise louvered shutters.

6. The furniture as recited in claim 1, further comprising a tray removably placed on said bottom wall for collecting bodily waste produced by the pet animal.

7. The furniture as recited in claim 1, further comprising a lower protective panel removably disposed on said bottom wall.

8. The furniture as recited in claim 7, further comprising a pair of side protective panels disposed within the chamber on said sidewalls.

9. The furniture as recited in claim 8, further comprising an upper protective panel disposed within the chamber on said top wall.

10. The furniture as recited in claim 1, further comprising a lower protective panel disposed within the chamber on said bottom wall.

11. The furniture as recited in claim 10, further comprising a pair of side protective panels disposed within the chamber on said sidewalls.

12. The furniture as recited in claim 11, further comprising an upper protective panel disposed within the chamber on said top wall.

13. The furniture as recited in claim 1, further comprising a water bottle mounted on one of said sidewalls for providing water to the pet animal.

14. The furniture as recited in claim 1, further comprising a plurality of adjustable blinds mounted to said rear wall, the blinds covering said grated vent.
